(19) United States
(12) Patent Application Publication
(10) Pub. No.: US 2008/0018600 A1
(43) Pub. Date: Jan. 24, 2008

(54) Optical input device

(75) Inventors: Ting-Teng Hou, San Chung City (TW); Hui-Chen Chang, San Chung City (TW); Chung-Nan Wang, San Chung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: KYE SYSTEMS CORP., San Chung City (TW)

(21) Appl. No.: 11/818,575

(22) Filed: Jun. 15, 2007

(30) Foreign Application Priority Data
Jul. 21, 2006 (TW) 095126844

(51) Int. Cl. G09G 5/00

(52) U.S. Cl. 345/161

(57) ABSTRACT

An optical input device is provided to be operated by a user to generate a vector signal. The optical input device includes an operating stick and an optics module. A reflecting body is disposed at a lower end of the operating stick, and the optics module has a light source and an optical sensor. The light source projects light onto the reflecting body and the light is reflected to generate a reflected image into the optical sensor. The operating stick is moved to drive the reflecting body, such that the reflected image into the optical sensor is changed to generate the vector signal.

### CROSS-REFERENCE TO RELATED APPLICATIONS

This non-provisional application claims priority under 35 U.S.C. § 119(a) on Patent Application No(s). 095126844 filed in Taiwan, R.O.C. on Jul. 21, 2007, the entire contents of which are hereby incorporated by reference.

### BACKGROUND OF THE INVENTION

1. Field of Invention

The present invention relates to an input operating device. More particularly, the present invention relates to an optical input device taking optical image change as a signal criterion.

2. Related Art

Recently, the multimedia entertainment market grows vigorously, all the software and hardware manufacturers continuously provide more novel and better game software and game consoles, such that the more novel and better software and hardware are provided and a game rocker of the main game control interface and should be developed and improved continuously.

A game pad in the prior art includes a base for accommodating electronic components and an operating stick standing on the base. The operating stick is provided to be moved frontward, backward, leftward, and rightward in a certain angle range. A plurality of displacement sensors is disposed in the base for detecting the displacement of the operating stick in each direction and converting the displacement into a corresponding displacement signal. Recently, most game pads use a variable resistor as the displacement sensor. However, since the variable resistor changes the resistance according to its deformation. During the operation of the game pad, frictional force is generated between the operating stick and the variable resistor, and signal noise may be caused by the abrasive wear on the variable resistor after a long time of friction, thereby resulting in an incorrect signal output. Particularly, when using the software of an action game such as a fighting game, the user is likely to exert a large force on the game pad, such that the abrasive wear becomes worse, which accelerates the shortening of the lifetime of the game pad. Also, the variable resistor is liable to be changed with the influences such as environmental temperature and humidity, and thus the accuracy and stability of the signal output are reduced. Furthermore, when using a variable resistor as the displacement sensor, it is necessary to perform a return-to-zero correction on the variable resistor before each operation of the game pad so as to obtain a correct outputted signal.

### SUMMARY OF THE INVENTION

In the game pad using a variable resistor as the displacement sensor, abrasive wear of the components of the game pad is produced, such that the signal output correspond to the control action of the user is interfered to be incorrect after a long time. Such a design of game pad is not realizable. In view of the above, the object of the present invention is to providing an optical input device taking an optical image change as a signal criterion.

Accordingly, an optical input device of the present invention is provided. The optical input device includes a body, an operating stick, a recovering member, an optics module, and a base. The body is combined with the base to form a housing. The operating stick is disposed in the body and is movable in multi-directions. The recovering member is disposed between the housing and the operating stick for recovering the operating stick to an initial position normally. A reflecting body is disposed at the lower end of the operating stick, and a return-to-zero mark is disposed in a central position of the bottom of the reflecting body. The optics module is disposed in the base and has a light source and an optical sensor. When a force is exerted on the operating stick to move the operating stick, the reflecting body is driven to move. The light source projects light onto the reflecting body and the light is reflected to generate an image into the optical sensor. When the reflecting body moves, the image entering the optical sensor is changed to generate a vector signal. When the force to drive the operating stick and reflecting body is removed, the recovering member returns the operating stick to the initial position, such that the optical sensor obtains a correct position of the return-to-zero mark and returns the position coordinate to zero.

According to the optically controlled device of the present invention, vector signal is generated and outputted according the change of the image in a non-contacting manner, so as to overcome the problem of outputting interfered signal being possible damage caused by the abrasive wear occurring in the variable resistor used as the displacement sensor. Moreover, the return-to-zero mark is designed as being capable of correcting the position coordinate automatically.

As for the features and examples of the present invention, the advantageous embodiments are given below with reference to the drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is an exploded view of an optical input device according to an embodiment of the present invention;

FIG. 2 is a cross-sectional view of the optical input device according to the embodiment of the present invention; and

FIGS. 3A, 3B, and 3C are schematic views of operating actions of the optical input device according to an embodiment of the present invention.

### DETAILED DESCRIPTION OF THE INVENTION

The optical input device of the present invention is used to be applied in (but not limited to) computer input devices such as a game rocker, a game pad, a mouse, and a keyboard, or integrated into various portable electronic devices, so as to be operated by the user to generate a vector signal. The following detailed embodiment takes the game pad as an illustration of the present invention.

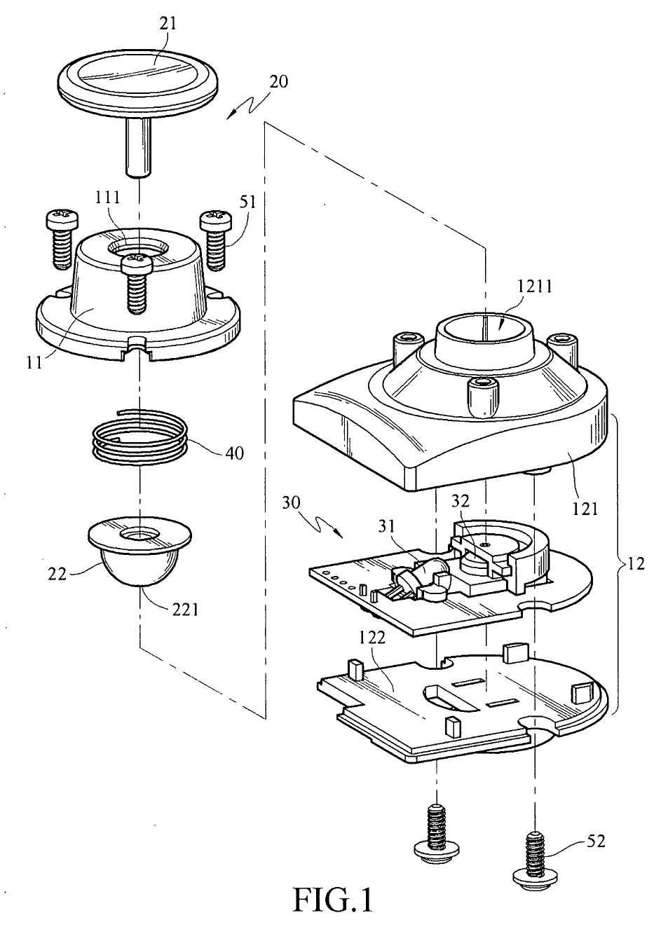

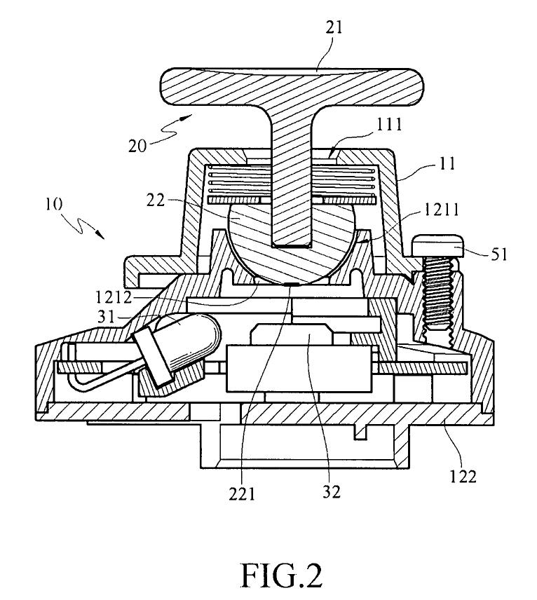

Referring to FIGS. 1 and 2, an optical input device according to an embodiment of the present invention includes a housing 10, an operating stick 20, and an optics module 30. The housing 10 has a body 11 and a base 12, wherein the body 11 is combined with the base 12 through screws 51 to form the housing 10. The body 11 is a hollow cylindrical cap, and an opening 111 is formed on the top of the body 11. The base 12 is a hollow square cap and includes an upper portion 121 and a lower portion 122. The base 12 has a spherical depression 1211 formed on the upper portion 121, and a through hole 1212 is formed on the bottom of the spherical depression 1211. The lower portion 122 is combined with the upper portion 121 through a plurality of screws 52.

The operating stick 20 is a cylindrical rod, there is a spherical (semispherical or ¾-sphere shape) reflecting body 22 disposed at the lower of the operating stick 20 and a operating pad 21 disposed on the upper end of the operating stick 20 opposite to the reflecting body 22. The reflecting body 22 has a first reflective surface formed on the bottom thereof. The first reflective surface is formed by coated reflective material with various irregular patterns, shining spots, and particles, or the first reflective surface is formed by micro textures or layers naturally formed on the reflecting body 22 during the production. Also, a return-to-zero mark 221 is disposed in a central position of the bottom of the first reflective surface of the reflecting body 22. The return-to-zero mark 221 is a second reflective surface, which includes (but not limited to) a non-reflective surface, a pit, a highly reflective surface, etc. used for differing the reflected light of the first reflective surface, such that the optics module 30 can sense the different intensities or the difference of the image change signal.

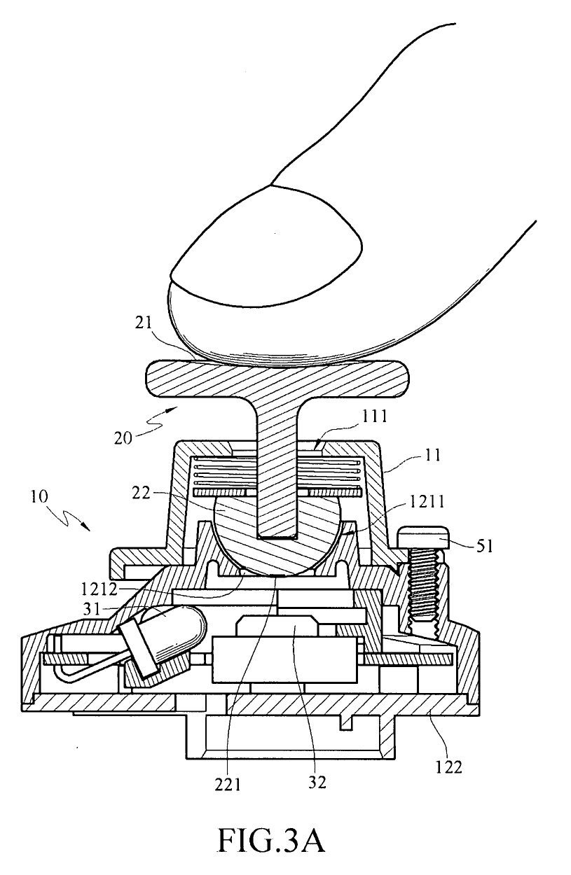

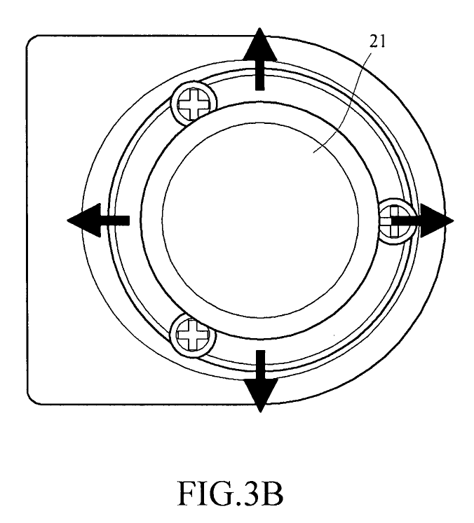

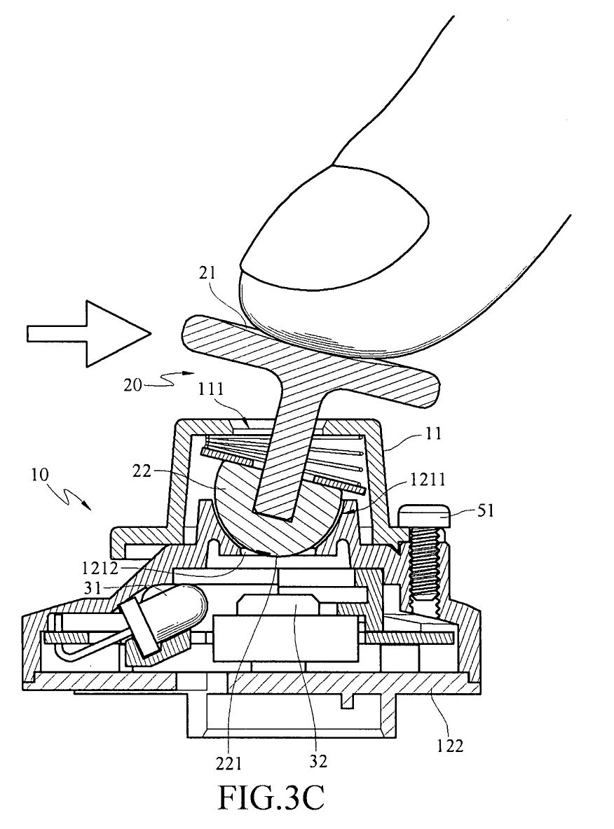

The operating pad 21 of the operating stick 20 protrudes outside the body 11 through the opening 111. The reflecting body 22 of the operating stick 20 is fitted in the spherical depression 1211 of the base 12 and is exposed through the through hole 1212. A recovering member 40 is disposed between the inner walls of the opening 111 of the body 11 and the reflecting body 22 of the operating stick 20. When a force is exerted on the operating pad 21, the operating stick 20 swings frontward, backward, leftward, and rightward within a range limited by the opening 111 (as shown in FIG. 3B), and thus the reflecting body 22 is driven to rotate in the spherical depression 1211 correspondingly, and different positions are exposed by the through hole 1212 during the rotation.

The recovering member 40 includes (but not limited to) an element capable of producing an elastic recovering force such as a spring, an elastic sponge, a elastic reed, and a plastic spring blade. Therefore, when the force exerted on the operating pad 21 is removed, the recovering member 40 makes the operating stick 20 stand on the body 11 vertically in a position defined as an initial position of the operating stick 20. At the initial position, the return-to-zero mark 221 of the reflecting body 22 is located in the central position of the portion exposed by the through hole 1212.

The optics module 30 is disposed on the base 12, and includes a light source 31 and an optical sensor 32. The light source 31 can be a light-emitting device such as a light-emitting diode (LED). The light source 31 is disposed on one side of the base 12 and projects light trough the through hole 1212 onto the reflecting body 22. The light is then reflected by the reflecting body 22 to generated an image. The optical sensor 32 is a charge coupled device (CCD) or a complementary metal-oxide semiconductor (CMOS), and is located right below the through hole 1212 for receiving the image generated by reflecting light with the reflecting body 22. The optics module 30 further includes a processor (not shown), and the optical sensor 32 is electrically connected to the processor (or further electrically connected to an external processor through a connecting wire or cable (not shown)). The change of the image is calculated by the processor calculates the change of the image reflected into the optical sensor 32, so as to generate a vector signal. That is, when the optical sensor 32 receives the reflected light of the first surface, a corresponding vector signal is generated; when the optical sensor 32 receives the reflected light of the second surface, a coordinate return-to-zero signal is generated.

As shown in FIGS. 3A, 3B, and 3C, in the optical input device according to the embodiment of the present invention, the operating stick 20 is normally located at the initial position by the recovering force of the recovering member 40. When the user exerts a force on the operating pad 21, the operating stick 20 swings on the body 11 in multi-directions, the reflecting body 22 is driven to rotate by the operating stick 20, and different positions of the reflecting body 22 are exposed by the through hole 1212 during the rotation. The light source 31 projects light through the reflecting body 22 on the reflecting body 22 continuously, the light are reflected by the reflecting body 22 to generated an image into the optical sensor 32, and then the change of the image is converted into a vector signal for being output after the change is calculated by the processor. When the force exerted by the user is removed, the recovering member 40 provides a recovering elastic force to recover the operating stick 20 to the initial position. After being recover to the initial position, different reflected images of the return-to-zero mark 221 enter the optical sensor 22 and are judged by the processor, and thus the optical sensor 32 obtains the correct position of the return-to-zero mark 221 to return the position coordinate to zero, thereby obtaining a correct vector signal for the next action.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical input device, comprising:
a housing;
an operating stick, disposed in the housing and movable in multi-directions;
a recovering member, disposed between the operating stick and the housing for recovering the operating stick to an initial position normally, wherein a reflecting body is disposed at the lower end of the operating stick, and a return-to-zero mark is disposed in a central position of the bottom of the reflecting body; and
an optics module, including a light source and an optical sensor, wherein the light source projects light onto the reflecting body, and the light is reflected to generate an image into the optical sensor, then the change of the image entering the optical sensor is calculated to generate a vector signal;
wherein, when the return-to-zero mark is located at the initial position, and the position coordinate retrieved from the vector signal is returned to zero.

2. The optical input device as claimed in claim 1, wherein the housing comprises:
a body, wherein an opening is formed on a top of the body, and a operating pad is disposed on an upper end of the operating stick opposite to the reflecting body and protrudes outside the body through the opening;
a base having a spherical depression formed thereon, wherein a through hole is formed on bottom of the spherical depression, and the reflecting body is fitted in the spherical depression and exposed through the through hole.

3. The optical input device as claimed in claim 1, wherein the reflecting body has a first reflective surface, and the return-to-zero mark is a second reflective surface.

4. An optical input device, comprising:
a housing;
an operating stick, having an upper end protruded from the housing and a lower end having a reflecting body disposed in the housing, wherein a return-to-zero mark is disposed in a central position of the bottom of the reflecting body; and
an optics module, comprising a light source and an optical sensor;
wherein the reflecting body reflects a first reflected light, and the optics module generates a corresponding vector signal;
wherein the return-to-zero mark reflects a second reflected light, and the optics module generates a return-to-zero signal.

5. The optical input device as claimed in claim 4, wherein the operating stick is further connected to a recovering member.

6. An optical input device, comprising:
an operating stick, having an operating end and the other end having a reflecting body;
wherein the reflecting body has a first reflective surface and a second reflective surface; and
an optics module, for projecting light onto the reflecting body, and receiving a reflected light;
wherein, the optics module receives the reflected light of the first reflective surface and generates a corresponding vector signal, and the optics module receives the reflected light of the second reflective surface and generates a return-to-zero signal.
